(19) United States
(12) Patent Application Publication
(10) Pub. No.: US 2013/0058222 A1
(43) Pub. Date: Mar. 7, 2013

(54) COLLISION HANDLING AND SYNCHRONIZATION OF NODES IN A CSMA/CA NETWORK

(71) Applicants: Yoav Ben-Yehezkel, Rehovot (IL); Ronen Gazit, Tel Aviv (IL)

(72) Inventors: Yoav Ben-Yehezkel, Rehovot (IL); Ronen Gazit, Tel Aviv (IL)

(21) Appl. No.: 13/596,924

(22) Filed: Aug. 28, 2012

Related U.S. Application Data
(60) Provisional application No. 61/529,100, filed on Aug. 30, 2011.

(51) Int. Cl. H04L 12/26

(52) U.S. Cl. 370/242

(57) ABSTRACT

A system and method of retaining synchronization in a shared medium communications network. Synchronization is maintained between colliding transmitters and receivers by providing a Collision Based Inter Frame Space (CBIFS) which is a time period at least as long as the longest frame and that starts from a point in time common to all nodes such as after the backoff period (beginning of the PHY header). After a collision is detected in either a transmitting or receiving node, the node waits the remaining time in the CBIFS period. For transmitters the node waits the remaining time period from the end of the frame transmission until the CBIFS period terminates. For receivers, the node waits from the end of the preamble until the CBIFS period terminates.

### REFERENCE TO PRIORITY APPLICATION

This application claims priority to U.S. Provisional Application Ser. No. 61/529,100, filed Aug. 30, 2011, entitled “Collision Handling and Synchronization of Nodes in a CSMA/CA Network,” incorporated herein by reference in its entirety.

### FIELD OF THE DISCLOSURE

The subject matter disclosed herein relates to the field of digital communications, and more particularly relates to a system and method for collision handling and synchronization of nodes in a Carrier Sense Multiple Access/Collision Avoidance (CSMA/CA) network.

### BACKGROUND OF THE INVENTION

Carrier sense multiple access with collision avoidance (CSMA/CA) in computer networking is a layer 2 network multiple access method in which carrier sensing is used where nodes attempt to avoid collisions by transmitting only when the channel is sensed to be “idle”. Collision avoidance is used to improve the performance of the CSMA method by attempting to divide the channel equally among all transmitting nodes with the collision domain.

CSMA/CA channel access requires that (1) all nodes in the network use the same timing (i.e. superframe) and that (2) all nodes are synchronized with each other (i.e. the superframe of all nodes start at the exact point in time).

When two nodes are transmitting at the same time on the channel and a collision occurs, this method of synchronization may fail as described below, creating a scenario where nodes become unsynchronized with one another wherein the EOP of each node is at a different point in time. This causes a considerable deterioration in performance of the channel access mechanism to the point where the network collapses.

### SUMMARY OF THE INVENTION

The present invention is a system and method of retaining synchronization in a shared medium communications network. Synchronization is maintained between colliding transmitters and receivers by providing a Collision Based Inter Frame Space (CBIFS) which is a time period at least as long as the longest frame and that starts from a point in time common to all nodes such as after the backoff period (beginning of the PHY header). After a collision is detected in either a transmitting or receiving node, the node waits the remaining time in the CBIFS period. For transmitters the node waits the remaining time period from the end of the frame transmission until the CBIFS period terminates. For receivers, the node waits from the end of the preamble until the CBIFS period terminates.

There is thus provided in accordance with the invention, a method of collision handling and synchronization for use in a communications node coupled to a communications medium, the method comprising detecting a potential collision with another node and waiting a time period starting from a known point in time common across all nodes.

There is also provided in accordance with the invention, a method of collision handling and synchronization for use in nodes within a Power Line Carrier (PLC) based communications system connected to a power line utility, the method comprising detecting a potential collision with another node and waiting a remaining time until a Collision Based Inter Frame Space (CBIFS) period terminates, the CBIFS period starting from a point in time common across all nodes.

There is further provided in accordance with the invention, a modem for use in a Power Line Carrier (PLC) based communication system connected to a power line utility comprising a transmitter operative to generate and transmit packets over the power line utility, each packet comprising a preamble portion consisting of preamble symbols and a data portion consisting of data symbols, a receiver coupled to the power line utility and operative to receive packets over the power line utility, a media access control (MAC) layer coupled to the transmitter and the receiver, the MAC operative to detect a potential collision with another node and wait a time period starting from a known point in time common across all nodes.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the mechanism of the present invention;

FIG. 2 is a high level block diagram illustrating an example communications system adapted to implement the mechanism of the present invention;

FIG. 3 is a diagram illustrating superframe synchronization based on end of packet (EOP);

FIG. 4 is a diagram illustrating example loss of synchronization of contention period (CP) starting point due to a collision;

FIG. 5 is a diagram illustrating example loss of synchronization of CP starting point due to a collision with deployment of EIFS period;

FIG. 6 is a diagram illustrating an example scenario of synchronization to the same CP starting point utilizing a CBIFS period;

FIG. 7 is a flow diagram illustrating the collision avoidance and synchronization method for use on the transmitter; and

FIG. 8 is a flow diagram illustrating the collision avoidance and synchronization method for use on the receiver.

### DETAILED DESCRIPTION

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CDROM), an optical storage device or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

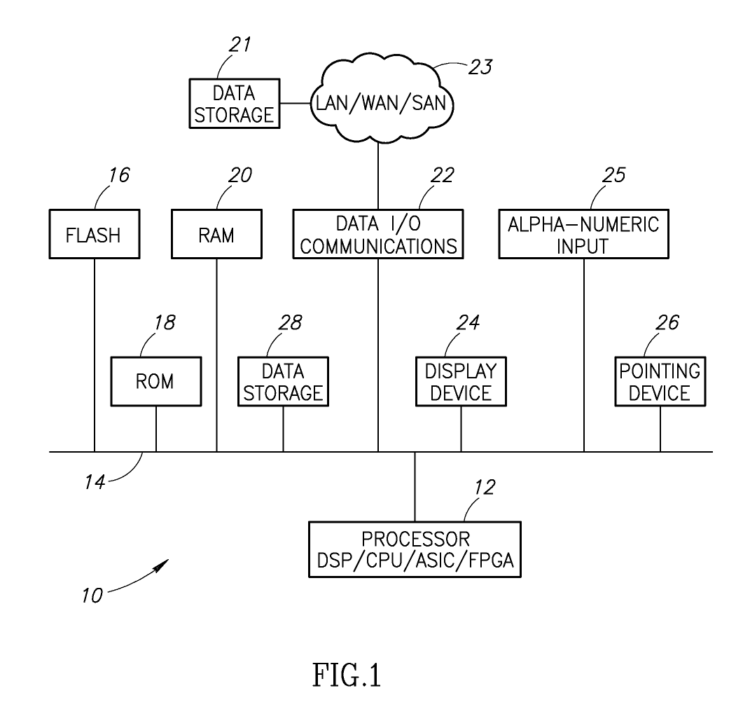

A block diagram illustrating an example computer processing system adapted to implement the system and methods of the present invention is shown in FIG. 1. The computer system, generally referenced 10, comprises a processor 12 which may comprise a digital signal processor (DSP), central processing unit (CPU), microcontroller, microprocessor, microcomputer, ASIC or FPGA core. The system also comprises static read only memory 18 and dynamic main memory 20 all in communication with the processor. The processor is also in communication, via bus 14, with a number of peripheral devices that are also included in the computer system. Peripheral devices coupled to the bus include a display device 24 (e.g., monitor), alpha-numeric input device 25 (e.g., keyboard) and pointing device 26 (e.g., mouse, tablet, etc.)

The computer system is connected to one or more external networks such as a LAN or WAN 23 via communication lines connected to the system via data I/O communications interface 22 (e.g., network interface card or NIC). The network adapters 22 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 21 and/or 28 for storing application programs and data. The system comprises computer readable storage medium that may include any suitable memory means, including but not limited to, magnetic storage, optical storage, semiconductor volatile or non-volatile memory or any other memory storage device.

Software adapted to implement the system and methods of the present invention is adapted to reside on a computer readable medium, such as a magnetic disk within a disk drive unit. Alternatively, the computer readable medium may comprise a floppy disk, removable hard disk, Flash memory 16, EEROM based memory, bubble memory storage, ROM storage, distribution media, intermediate storage media, execution memory of a computer, and any other medium or device capable of storing for later reading by a computer a computer program implementing the method of this invention. The software adapted to implement the system and methods of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the system and methods of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

### Example Communications System

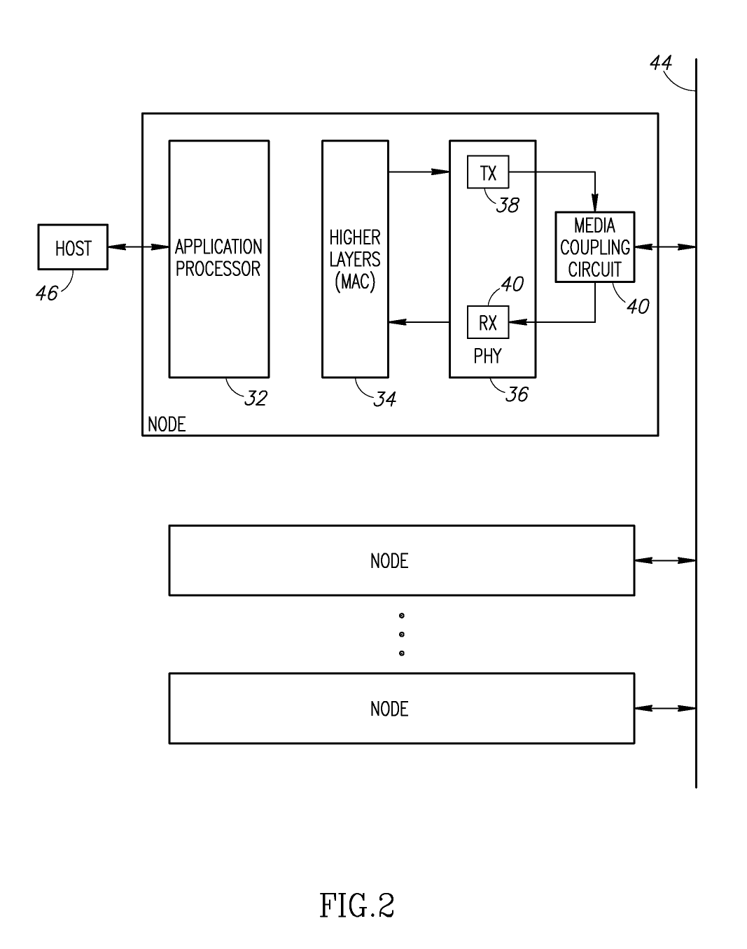

A high level block diagram illustrating an example communications system adapted to implement the mechanism of the present invention is shown in FIG. 2. The communication system typically comprises a plurality of nodes 30, coupled to a media 44 (e.g., the power line). In one embodiment, a node comprises a media coupling circuit 38, a PHY layer 36, higher layers 34 (e.g., MAC) and optionally an application processor 32 having an interface to a host 46. The PHY layer circuit comprises at least a transmitter 38 and receiver 40. In some cases, a node may comprise only a transmitter or only a receiver. In an alternative embodiment, the MAC and the application layers may be implemented by the same processor. Further, the interface may be to some other entity and not necessarily a host. The application may, in one embodiment, comprise the host, e.g., in the event the node is connected to a utility meter or to an appliance.

The transmitter typically comprises a digital processing function, a digital to analog convertor (DAC) and a power amplifier. The receiver typically comprises a filter, a variable gain device, an analog to digital convertor (ADC) and a digital processing function. The receiver may also comprise a low noise amplifier before or after the variable gain device. The digital processing functions may be implemented using dedicated digital circuitry, general purpose processors, digital signal processors (DSP), or any combinations thereof. Media coupling circuit 40 provides the interface for the transmitter and receiver to the media 44.

A digital communication system transmits digital information from a first node (referred to as the transmitting node) to a second node (referred to as the receiving node) over the transmission media 44. The media coupling circuit 40 couples the transmitter and the receiver to the transmission media. In wireless systems, the media coupling circuit typically comprises an antenna. In wired systems, the media coupling circuit typically comprises a coupler connecting the nodes to the wires.

In some wired communication systems, the transmission media may comprise a network of dedicated wires. In other communication systems, the transmission media may comprise a network of wires with another primary use. For example, the transmission media of power line communication (PLC) systems is an outdoor and/or an in-house electric grid.

A communication system utilizes a given part of the electromagnetic spectrum, referred to as the transmission band or the operation band. For example, some PLC systems operate within the 2 to 50 MHz band, referred to as the high PLC band. Some PLC systems operate within the 0 to 500 kHz band, referred to as the low PLC band. More specifically, some PLC systems operate within the 20 to 95 kHz band, the 95 to 125 kHz band and the 0 to 500 kHz band, referred to as the CELENEC A, the CENELEC B, and the FCC bands, respectively.

The path over the transmission media connecting the transmitting node to the receiving node is referred to as the propagation channel or simply the channel. The channel is characterized by its response, which can be expressed in the time domain as the channel impulse response or in frequency domain as the channel frequency response. In some cases, the frequency response of the channel is relatively “flat”, while in other cases the frequency response of the channel may exhibit considerable gain and phase variations over the transmission band. In some cases, the channel response is relatively stable over time, while in other cases the channel response may exhibit considerable temporal variations. In some cases, the temporal variations of the channel response follow a periodic pattern. In some cases, for example in PLC systems, the channel response changes periodically, at a period that is half of the AC cycle (e.g., at a period of 8.3 or 10 ms for mains frequency of 60 or 50 Hz, respectively).

CSMA/CA and Collision Based Inter Frame Space (CBIFS)

Carrier sense multiple access with collision avoidance (CSMA/CA) in computer networking is a layer 2 network multiple access method in which carrier sensing is used where nodes attempt to avoid collisions by transmitting only when the channel is sensed to be “idle”. Collision avoidance is used to improve the performance of the CSMA method by attempting to divide the channel equally among all transmitting nodes with the collision domain.

CSMA/CA channel access requires that (1) all nodes in the network use the same timing (i.e. superframe) and that (2) all nodes are synchronized with each other (i.e. the superframe of all nodes start at the exact point in time).

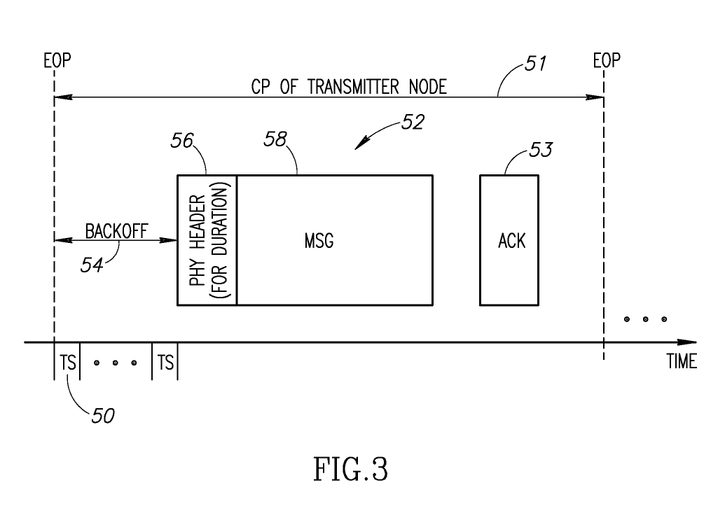

A diagram illustrating superframe synchronization based on end of packet (EOP) is shown in FIG. 3. The superframe comprises the contention period (CP) 51 of the transmitter node packet (also referred to as frame) which includes a backoff period 54 of a plurality of time slots (TS) 50, packet 52 comprising a PHY header 56 and message payload 58, and acknowledgement (ACK) 53. The EOP is indicated by dashed line 55.

Note that in many digital communication systems, information is transmitted from the transmitting node to the receiving node in a form of packets (or frames). The packet typically comprises a preamble and a data portion which comprises a header portion and a payload portion. The payload portion typically carries the content of the packet. The preamble, which comprises a known signal, is typically utilized by the receiver for detecting the beginning of a new packet, for time synchronization and for channel estimation. The payload portion usually comprises the content of the packet. The transmission parameters of the payload portion usually vary between packets and are therefore usually not known a priori to the receiver. The header portion, whose parameters are typically known a priori to the receiver, usually comprises the parameters of the payload portion thus enabling the receiver to detect and decode the payload.

In one embodiment, the end of the last transmission, the End of Packet (EOP) is used as a point for re-synchronization and start of a new superframe. The EOP is known to transmitters as they know the duration of the frame, and it is known to receivers based on the PHY header that indicates the duration of the transmitted frame for Virtual Carrier Sense (VCS) purposes.

When two nodes are transmitting at the same time on the channel and a collision occurs, this method of synchronization may fail as described below, creating a scenario where nodes become unsynchronized with one another wherein the EOP of each node is at a different point in time. This causes a considerable deterioration in performance of the channel access mechanism to the point where the network collapses.

Further, in modern communication systems, such as OFDM, detection of ongoing transmission on the communications medium is mandated on the detection of the packet preamble (called packet synchronization). Detection of ongoing transmission can only occur at the time of detection of the preamble. If the preamble is not detected, it is not possible to differentiate ongoing transmission from random noise. Thus, even in the event another node is transmitting, a listening node will not be able to detect the transmission outside of the preamble.

With CSMA/CA techniques, nodes contend for the channel by randomizing a period of time or by randomizing an integer number time slots (denoted as “TS”) before accessing the channel. The nodes count down the randomized period starting at a point of time called the contention period (CP). If a transmitter does not receive a Carrier Sense (CS) indication during the entire backoff count down period, it starts transmitting. In the event multiple transmitters randomize the same value for their backoff (which may happen), their transmissions will collide. A collision is part of the basic nature of a CSMA/CA protocol.

CSMA/CA requires that all nodes start the backoff count down at the same reference point such that only nodes that randomized the same value will transmit at the same time and collide. As defined herein, the reference point for all nodes when they are synchronized is denoted Contention Period (CP).

When all nodes measure the start of the contention period from the same EOP they remain synchronized and the CSMA/CA mechanism works properly as shown in FIG. 3.

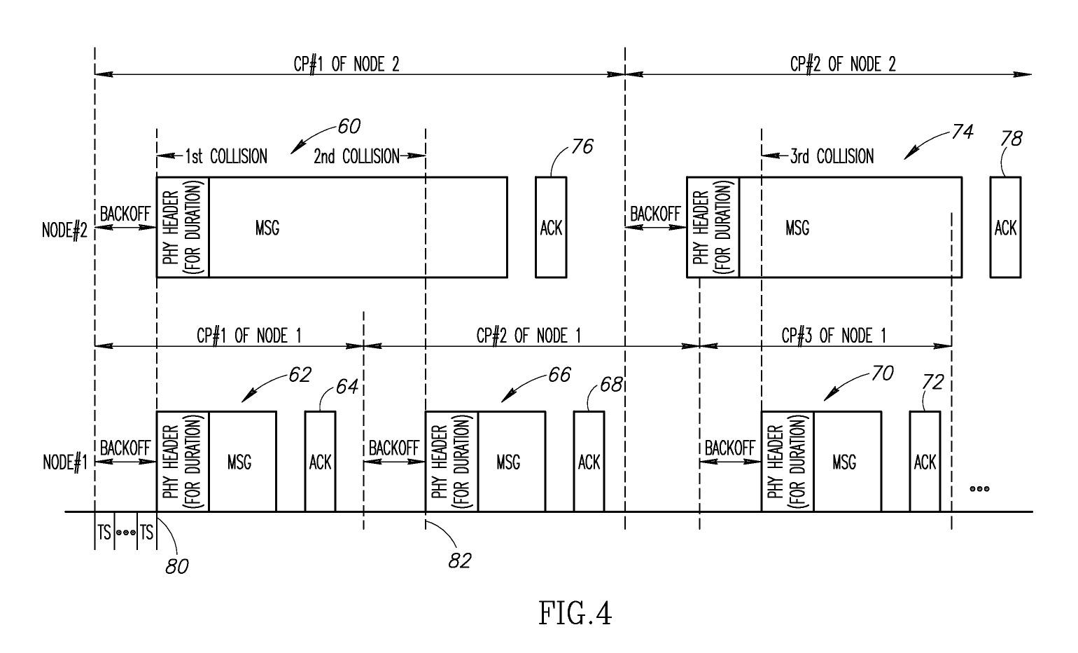

In the case of a collision, however, nodes may be unable to measure the start of the contention period from the same EOP, resulting in a lack of synchronization in the network. A diagram illustrating example loss of synchronization of contention period (CP) starting point due to a collision is shown in FIG. 4. The example shows a first collision (point 80) between two transmitters (i.e. node #1 and node #2) transmitting a packet having different durations on the channel. One of the colliding transmitters (node #1) finishes its packet 62, 64 transmission before the other colliding transmitter (node #2) finishes its packet 60, 76. Since there is no carrier sense (CS), the node #1 transmitter does not detect the transmission of node #2 and continues with its superframe and starts the next transmission before the node #2 transmitter finishes transmitting its packet 60. A second collision occurs at point 82 between node #1 transmitter's packet 66 and node #2 transmitter's packet 60.

Node #2 transmitter finished its transmission, receives an erroneous ACK and attempts to retransmit its packet 74 after waiting a random backoff period. Node #1 transmitter attempts a third transmission after waiting a random backoff period. A third collision occurs at point 84 since the node #1 transmitter is again unaware of transmission by the node #2 transmitter. This pattern of collision continues in subsequent transmissions such that a chain of continuous collisions occur between the same set of transmitters.

In addition, some receivers may detect a preamble but without proper detection of a PHY header. In this case they will not be able to determine the duration of transmission on the channel causing these nodes to lose synchronization as well, leading to a further deterioration in network conditions.

In one embodiment that attempts to solve this chain of collisions problem, the nodes are modified to wait a period that is equal to the longest possible frame duration (denoted Extended Inter-Frame Space or EIFS) from the end of the frame transmission on collision by transmitters.

Receivers, on the other hand, wait the same EIFS period, but starting from a different point, since they are aware of the collision in the case where the preamble is detected but the PHY header is incorrectly decoded. Thus, the actual starting point of measurement of the EIFS can be either (1) when the preamble started, (2) when it ended or (3) when the header was incorrectly decoded, as long as the starting point is the same between all nodes in the network. This is because the preamble and header durations are fixed.

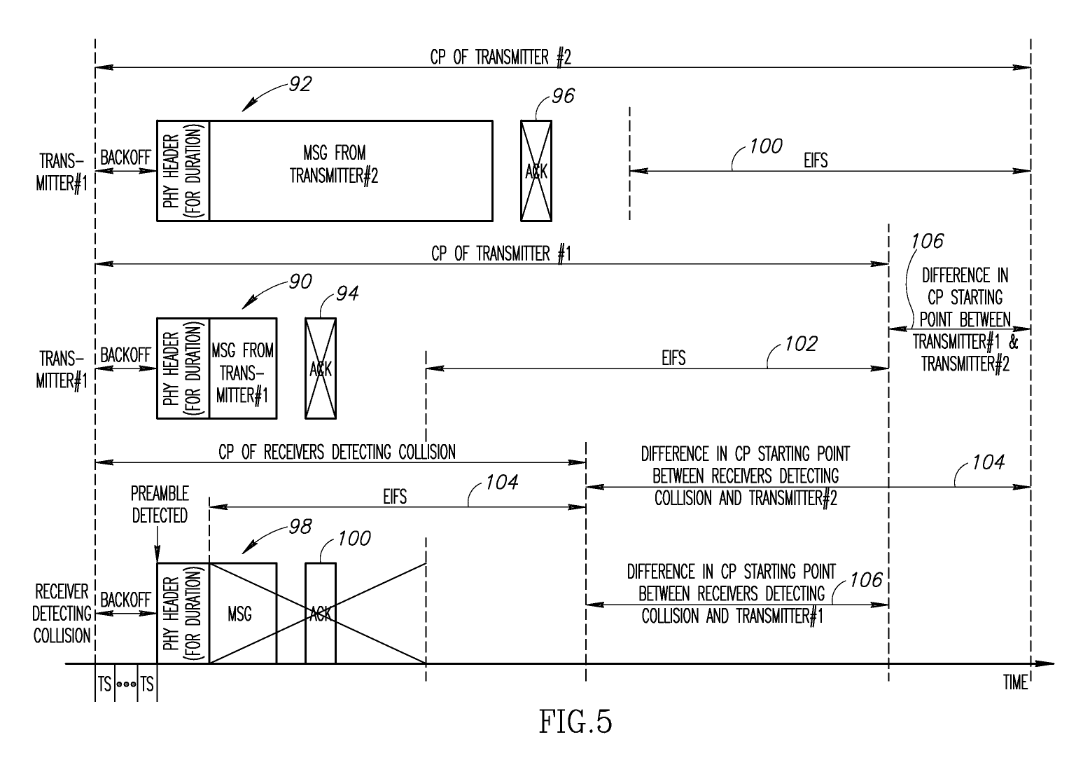

Since this EIFS period is counted starting from different time points for each colliding transmitter and the receivers that detected the collision, there will be a difference in the starting point of the next CP between the colliding transmitters and the receivers. This is illustrated in FIG. 5 which shows an example loss of synchronization of CP starting point due to a collision with deployment of EIFS period.

The transmitters of nodes #1 and #2 randomize to the same backoff period resulting in a collision. Receivers listening detect the preamble but receive the packet in error due to the collision between transmitters #1 and #2. According to the above scheme, the receivers wait the EIFS period 104 starting from the end of the preamble. Transmitter #1 starts its EIFS period 102 starting from after an erroneous ACK 94. Transmitter #2 starts its EIFS period 100 starting from after an erroneous ACK 96.

The three EIFS periods 100, 102, 104 all end at a different time resulting in a difference 106 in the CP starting point between transmitters #1 and #2; a difference 107 in the CP starting point between receivers detecting a collision and transmitter #2; and a difference 108 in the CP starting point between receivers detecting a collision and transmitter #1. The different CP starting points leave the receivers and transmitters #1 and #2 in an unsynchronized state.

Although the use of an EIFS period is effective to solve the problem of the chain of continuous collisions between the same set of transmitters as described supra, it does not, however, solve the synchronization problem. Leaving the nodes unsynchronized after the collision causes potential degradation to network performance. For example, a few backoff slots are reserved for high priority frames. Due to the lack of synchronization between the receivers and transmitters, the receivers that start their contention period earlier than the transmitters with a normal priority frame may transmit in one of the backoff slots that the transmitter mistakes for an urgent frame, causing the application to react in an unexpected manner. Moreover, in the case when the transmitters have an urgent frame to transmit, because the receivers start to contend earlier, they might start to transmit with a normal priority frame earlier than the transmitter that had an urgent frame to transmit, causing an undesired delay to urgent frames. In addition, the fact that receivers start to contend earlier than transmitters also gives them an unfair advantage in the next contention period over the transmitters.

Thus, in order to retain synchronization between colliding transmitters the present invention provides for a Collision Based Inter Frame Space (CBIFS) that transmitters and receivers use to keep themselves synchronized. The CBIFS period is measured from the beginning of a previously known starting point that is common to all nodes. For example, the beginning point in time of the CBIFS period is the contention period (i.e. end of the backoff or beginning of the preamble). Other points for the beginning of the CBIFS period may be used as long they are common for all nodes. For transmitters, the node waits the remaining time from the end of the frame transmission until the CBIFS period terminates. For receivers, the node waits the remaining time from the end of the preamble until the CBIFS period terminates. For both transmitting and receiving nodes, however, the total CBIFS time period is the same with the start of the period being the same for all nodes. Note that in one embodiment, a transmitting node detects a potential collision by either (1) not receiving an acknowledgement or (2) receiving a failure in the acknowledgement, and thus wait before starting the next contention period.

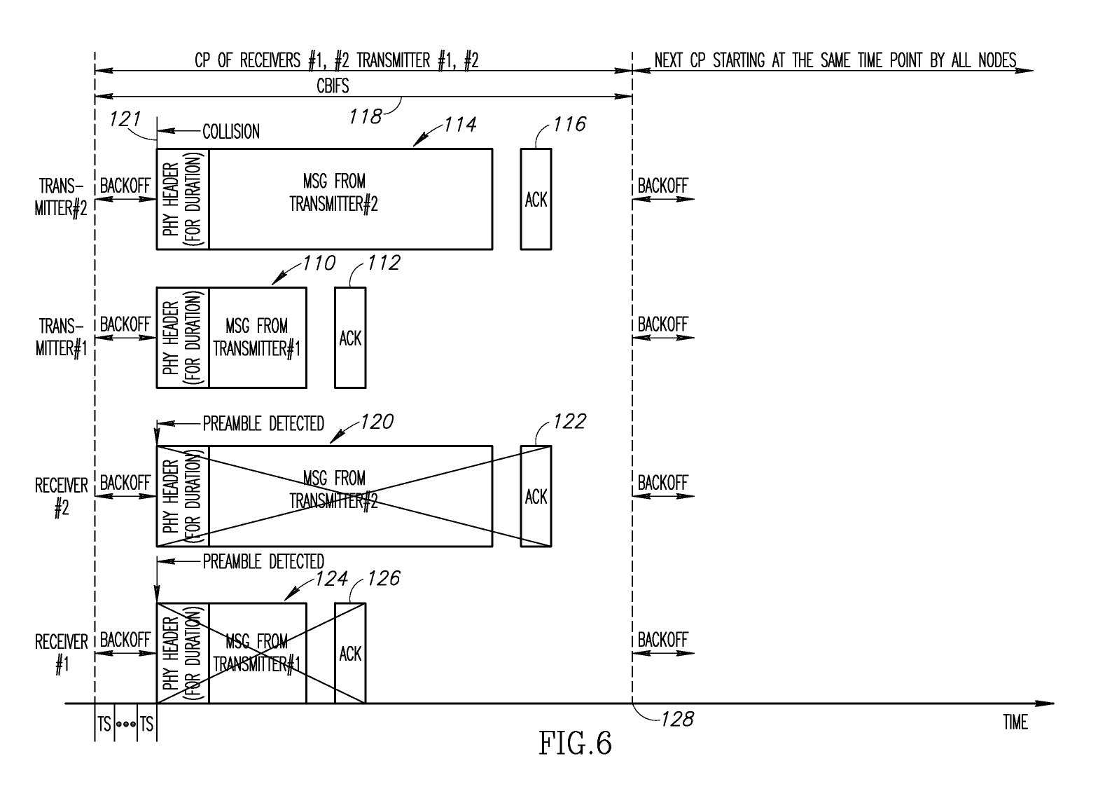

A diagram illustrating an example scenario of synchronization to the same CP starting point utilizing a CBIFS period is shown in FIG. 6. Two colliding transmitters (transmitter #1 and transmitter #2) are shown along with two listening receivers (receiver #1 and receiver #2). A collision occurs at point referenced 121 between transmitter #1 sending message 110 and transmitter #2 sending message 114. Both receiver #1 and #2 here a preamble but do not properly receive either message 120 or 124. The transmitters detect an error when they do not properly receive acknowledgements 116 or 112. To regain synchronization, the transmitters and receivers wait the remaining time in the CBIFS period 118 measured from the last synchronization point known to both transmitters and receivers to the next contention period.

In order for receivers that are also contenders detect the preamble but not the frame duration (which is usually transmitted using robust communication parameters and therefore less likely not to be received) as described above, the receivers resynchronize to the beginning of the next contention point (referenced point 128) at the same time point as the transmitters, by implicitly assuming that a detection of a preamble with an incorrect PHY header detection indicates collisions between transmitters and by measuring the same CBIFS period from the same starting point of the transmitters, which is the last known synchronization point between transmitters and receivers.

Note that in one embodiment, the CBIFS period is calculated to be at least as long as the longest possible frame duration plus an optional margin to take into account some backoff time. To increase efficiency, in one embodiment, if a preamble is detected with a PHY header received without error during the CBIFS period, the next CP shall start after the end of the currently received frame.

Configuring the nodes in the network to use the CBIFS period to retain synchronization has the advantages of (1) avoiding the collapse of the network due to the chain of collisions in the CP following the one in which the collision occurred as shown and described in connection with FIG. 4; and (2) colliding transmitters and receivers begin their next CP synchronized to the same point in time thereby increasing network efficiency and reliability and eliminating the requirement of waiting the EIFS period.

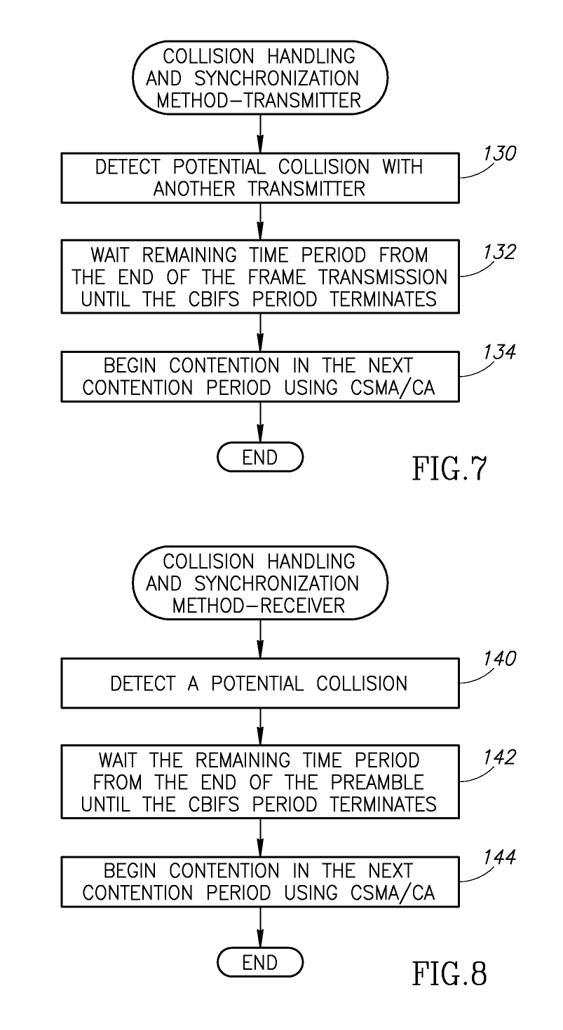

A flow diagram illustrating the collision avoidance and synchronization method for use on the transmitter is shown in FIG. 7. A transmitting node first detects a collision with another transmitter (step 130). For example, a node can detect a potential collision with another transmitter by (1) not receiving an acknowledgement (ACK) when requested from the receiver or (2) receiving a negative ACK response from the receiver. Once the collision is detected, the node then waits the remaining time period from the end of the frame transmission until the CBIFS period terminates, where the CBIFS period is counted from the beginning of the pervious CP starting point (step 132). Contention then begins in the next contention period using CSMA/CA techniques (step 134).

A flow diagram illustrating the collision avoidance and synchronization method for use on the receiver is shown in FIG. 8. A receiving node first detects a potential collision step (140). For example, a node can detect a collision by receiving a preamble with an incorrect PHY header. Once a collision is detected, the node waits the remaining time from the end of the preamble until the CBIFS period terminates, while counting the CBIFS period from the beginning of the previous CP starting point (step 142). Contention then begins in the next contention period using CSMA/CA (step 144).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of collision handling and synchronization for use in a communications node coupled to a communications medium, said method comprising:
detecting a potential collision with another node; and
waiting a time period starting from a known point in time common across all nodes.

2. The method according to claim 1, wherein said detecting comprises detecting a collision with another transmitter by failing to receive an acknowledgement.

3. The method according to claim 1, wherein said detecting comprises detecting a collision with another transmitter by receiving a negative acknowledgement.

4. The method according to claim 1, wherein said detecting comprises detecting a collision with another transmitter by receiving an erroneous acknowledgement.

5. The method according to claim 1, wherein said detecting comprises detecting a collision by detecting a preamble with an incorrect PHY header.

6. The method according to claim 1, wherein said time period comprises a Collision Based Inter Frame Space (CBIFS).

7. The method according to claim 1, wherein said time period is at least as long as the longest possible frame.

8. The method according to claim 1, wherein said known point in time comprises the start of a contention period.

9. The method according to claim 1, wherein said known point in time comprises the start of reception of a PHY header.

10. The method according to claim 1, further comprising beginning contention in a next contention period using CSMA/CA.

11. A method of collision handling and synchronization for use in nodes within a Power Line Carrier (PLC) based communications system connected to a power line utility, said method comprising:
detecting a potential collision with another node; and
waiting a remaining time until a Collision Based Inter Frame Space (CBIFS) period terminates, said CBIFS period starting from a point in time common across all nodes.

12. The method according to claim 11, wherein said CBIFS period begins from any known time point common across all nodes.

13. The method according to claim 11, wherein said CBIFS period begins from the beginning of a previous contention period.

14. The method according to claim 11, wherein said CBIFS period begins from the end of a previous backoff period.

15. The method according to claim 11, wherein said CBIFS period begins from the start of PHY header reception.

16. The method according to claim 11, wherein said CBIFS period is measured from the beginning of a previously known starting point of a contention period where transmitters that do not receive an acknowledgement or an erroneous acknowledgement wait before starting a next contention period.

17. The method according to claim 11, further comprising beginning contention in a next contention period using CSMA/CA.

18. A modem for use in a Power Line Carrier (PLC) based communication system connected to a power line utility, comprising:
a transmitter operative to generate and transmit packets over said power line utility, each packet comprising a preamble portion consisting of preamble symbols and a data portion consisting of data symbols;
a receiver coupled to said power line utility and operative to receive packets over said power line utility;
a media access control (MAC) layer coupled to said transmitter and said receiver, said MAC operative to:
detect a potential collision with another node; and
wait a time period starting from a known point in time common across all nodes.

19. The modem according to claim 18, wherein said CBIFS period begins from any known time point common across all nodes.

20. The method according to claim 18, wherein said CBIFS period is measured from the beginning of a previously known starting point of a contention period where transmitters that do not receive an acknowledgement or an erroneous acknowledgement wait before starting a next contention period.

21. The modem according to claim 18, wherein said CBIFS period begins from the beginning of a previous contention period.

22. The modem according to claim 18, wherein said CBIFS period begins from the end of a previous backoff period.

23. The modem according to claim 18, wherein said CBIFS period begins from the start of PHY header reception.
